(19) United States
(12) Patent Application Publication
(10) Pub. No.: US 2024/0147018 A1
(43) Pub. Date: May 2, 2024

(54) SYSTEMS, METHODS, AND DEVICES FOR AUTOMATIC TEXT OUTPUT

(71) Applicant: Comcast Cable Communications, LLC, Philadelphia, PA (US)

(72) Inventor: Philip D. Mooney, Sellersville, PA (US)

(21) Appl. No.: 18/051,965

(22) Filed: Nov. 2, 2022

(51) Int. Cl. H04N 21/488; G06F 16/783; H04N 21/45

(52) U.S. Cl. CPC H04N 21/4884; G06F 16/783; H04N 21/4532

(57) ABSTRACT

Data indicative of reduced intelligibility in a content item may be received from a plurality of devices, users, or from audio data associated with the content. At least one portion of the content item associated with reduced intelligibility may be determined based on the data indicative of reduced intelligibility in the content item. Text data indicative of audio associated with the at least one portion of the content item may be automatically caused, via at least one different device, for a duration of the at least one portion of the content item.

### BACKGROUND

Content items may be output for consumption by one or more users. The content items may be output, for example, by client devices associated with the one or more users. However, the one or more users may sometimes have difficulty hearing audio during output of certain portions of the content item. Such difficulty may result in a poor user experience. For example, the one or more users may become frustrated and/or may be unable to enjoy consumption of the content item. Therefore, improvements in content output techniques are needed.

### SUMMARY

Systems, methods, and devices relating to automatic text output are described herein. Data collected from a plurality of client devices during previous outputs of a content item may indicate reduced intelligibility in the content item. For example, the data may indicate when each the plurality of devices rewinded the content item, when each of the plurality of devices initiated output of closed captioning, or when each of the plurality of devices terminated output of closed captioning. Based on this data, at least one portion of the content item that is associated with reduced intelligibility may be determined. For example, a start time and/or an end time of at least one portion of the content item that is associated with reduced intelligibility may be determined. During a later output of the content item via a different client device, text data indicative of audio associated with the at least one portion of the content item may be automatically output for the duration of the at least one portion of the content item.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to limitations that solve any or all disadvantages noted in any part of this disclosure.

### BRIEF DESCRIPTION OF DRAWINGS

The accompanying drawings, which are incorporated in and constitute a part of this specification, illustrate embodiments and together with the description, serve to explain the principles of the systems, methods, and devices:

FIG. 1 shows a system.

FIG. 2 shows an example client device.

FIG. 3 shows an example client device.

FIG. 4 shows an example method.

FIG. 5 shows an example method.

FIG. 6 shows an example method.

FIG. 7 shows an example method.

FIG. 8 shows an example computing system.

Aspects of the disclosure will now be described in detail with reference to the drawings, wherein like reference numbers refer to like elements throughout, unless specified otherwise.

### DETAILED DESCRIPTION

Content items may be output for consumption by one or more users. The content items may be output, for example, by client devices associated with the one or more users. However, the one or more users may sometimes have difficulty hearing audio during output of certain portions of the content item. For example, the one or more users have a difficult time hearing the audio during a certain portion of a movie or television show. Such difficulty may result from the users being hearing impaired, from loud/distracting background noises in the content item, from poor recording quality associated with the content item, and/or for a number of other reasons. Such difficulty may result in a poor user experience. For example, the one or more users may become frustrated and/or may be unable to enjoy consumption of the content item.

The one or more users may be able to turn on closed captioning during output of content items. Turning on closed captioning may provide the one or more users with on-screen text indicative of the content item's audio. In this manner, the one or more users may be able to understand the audio even during difficult-to-hear portions of the content item. However, many users do not want closed captioning turned on for the duration of the entire output of the content item because it is a distraction. When such users encounter a difficult-to-hear portion of the content item, they may need to rewind output of the content item, manually turn on closed captioning during the difficult-to-hear portion, and later manually turn closed captioning off in order to enjoy consuming the remainder of the content item. Such manual control of closed captioning is not ideal, as the users may become frustrated at continually having to turn closed captioning on/off. As a result, the users may not fully enjoy consumption of the content item.

Accordingly, it may be desirable to cause, without user input, output of text during output of portions of a content item that are associated with reduced intelligibility (e.g., reduced audibility, audio that is difficult to understand or comprehend, low volume audio, difficult to hear audio, etc.). It may also be desirable to terminate, without user input, the output of text after the portions of the content item that are associated with reduced intelligibility have been output.

Data collected from a plurality of client devices during previous outputs of the content item may be utilized to cause output of text during output of portions of a content item that are associated with reduced intelligibility. Such data may indicate reduced intelligibility in the content item. For example, the data may indicate when/if each the plurality of devices rewinded the content item, when/if each of the plurality of devices initiated output of closed captioning, and/or when/if each of the plurality of devices terminated output of closed captioning. Based on this data, at least one portion of the content item that is associated with reduced intelligibility may be determined. During later output(s) of the content item via at least one different client device, text data indicative of audio associated with the at least one portion of the content item may be automatically output for the duration of the at least one portion of the content item. In this manner, the user associated with the different client device(s) may not need to manually turn on/off closed captioning while consuming the content item.

Additionally, or alternatively, data generated by a client device (e.g., a set-top-box) that is causing output of a content item may be utilized to cause output of text during output of portions of the content item that are associated with reduced intelligibility. The client device may comprise a speech-to-text converter. The client device may be configured to continuously monitor audio associated with the content item to determine if the audio is able to be converted to text (e.g., by the speech-to-text converter). Audio may be able to be converted to text if the speech-to-text converter is able to convert the audio to text that matches (e.g., corresponds to) closed captioning data associated with the content item. If audio associated with a first portion of the content item matches the closed captioning data associated with the first portion of the content item, the first portion of the content item may not be associated with reduced intelligibility. Conversely, if audio associated with a second portion of the content item does not match the closed captioning data associated with the second portion of the content item, the second portion of the content item may be associated with reduced intelligibility. Text data indicative of audio associated with the second portion of the content item may be automatically output for the duration of the second portion of the content item. In this manner, the user associated with the different client device(s) may not need to manually turn on/off closed captioning while consuming the content item.

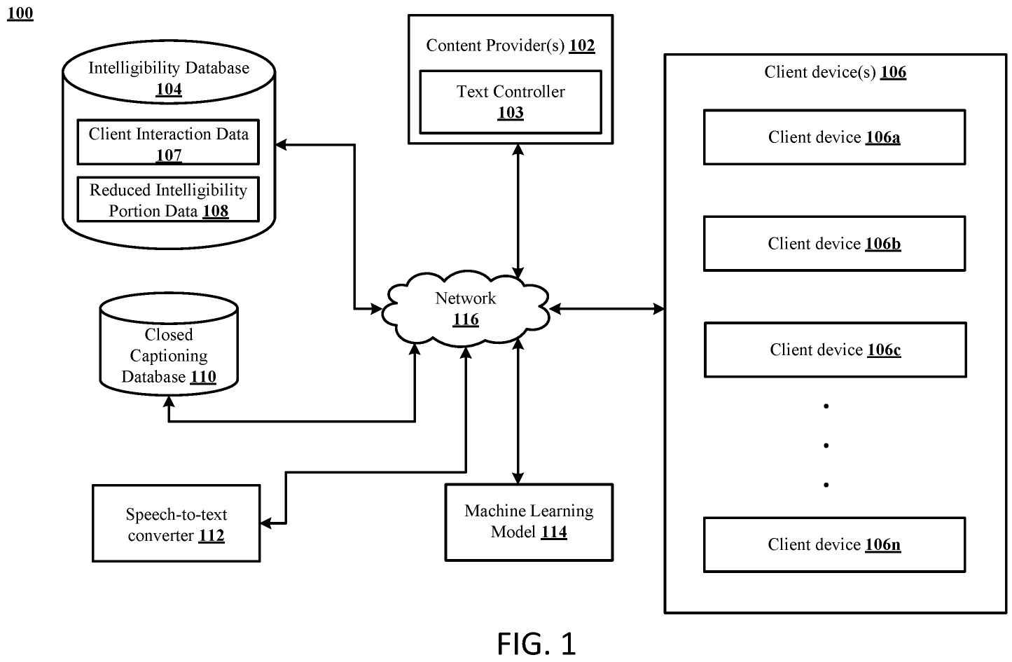

FIG. 1 shows an example network in which the present systems, methods, and devices may be implemented. As shown in FIG. 1, a media network 100 may comprise at least one content provider(s) 102, an intelligibility database 104, a plurality of client devices 106a-n, a closed captioning database 110, a machine learning model 114, and/or a speech-to-text converter 112. The content provider(s) 102, the plurality of client devices 106a-n, the intelligibility database 104, the closed captioning database 110, the machine learning model 114, and/or the speech-to-text converter 112 may be in communication via a network 116.

The network 116 may comprise a local area network, a wide area network, a wireless network, a wired network, the Internet, a combination thereof, or any other type of network over which the components of the media network 100 may communicate. The network 116 may comprise one or more public networks (e.g., the Internet) and/or one or more private networks. A private network may include a wireless local area network (WLAN), a local area network (LAN), a wide area network (WAN), a cellular network, or an intranet. The network 116 may comprise wired network(s) and/or wireless network(s).

The content provider(s) 102 may distribute content to households and/or client devices, such as the client devices 106. Non-limiting examples of a content provider(s) 102 include a television broadcast network, a cable television network, a satellite television network, an internet service provider (ISP), a computing device advertising network, a media distribution network, a cloud computing network, a local area network (LAN), a wide area network (WAN), or any combination thereof. The content provider(s) 102 may transmit content to one or more local content systems configured to communicate with an audience (e.g. a plurality of households) of the media network 100. The local content systems may include equipment and systems configured to transmit content received from the content provider to a defined portion of the audience (e.g. one or more defined household segments). Illustrative and non-restrictive examples of a local content system include a cable television network headend, an internet service provider base station, or the like.

The content transmitted by the content provider(s) 102 may include one or more content items. A content item may comprise, as an example, a video program. A video program may refer generally to any video content produced for viewer consumption. A video program may comprise video content produced for broadcast via over-the-air radio, cable, satellite, or the internet. A video program may comprise video content produced for digital video streaming or video-on-demand. A video program may comprise a television show or program. A video program series may comprise two or more associated video programs. For example, a video program series may include an episodic or serial television series. As another example, a video program series may include a documentary series, such as a nature documentary series. As yet another example, a video program series may include a regularly scheduled video program series, such as a nightly news program.

The content provider(s) 102 may be configured to operate across physical device platforms and networks simultaneously. For example, content may be delivered by the content provider(s) 102 (such as via one or more local content systems) to set-top-boxes (STBs) and/or digital video recorders (DVRs) over a cable television system, to mobile computing devices using standard network communication protocols (for instance, Ethernet or Wi-Fi) over an ISP network, to smart devices over standard telecommunication protocols (for instance, third Generation (3G), fourth Generation (4G), long-term evolution (LTE), or the like), and to home gateway devices through a LAN, WAN and/or ISP network.

The content may be distributed by the content provider(s) 102 to an audience. The audience may include households that each comprise one or more client devices 106 capable of receiving content from the media network 100. The client devices 106 may comprise any one of numerous types of devices configured to effectuate content output (e.g., playback) and/or viewing. The client devices 106 may be configured to receive content and output the content to a separate display device for consumer viewing.

Non-limiting examples of a client device 106 include a set-top box (STB), such as a cable STB. A STB may receive video content via a cable input (e.g., co-axial cable or fiber optic cable) and format the received video content for output to a display device. A STB may receive video content via digital video streaming. A STB (or other type of video device) may comprise a quadrature amplitude modulation (QAM) tuner. A STB may comprise a digital media player or a gaming device.

A client device 106 may comprise a digital video recorder (DVR) that receives and stores video content for later viewing. A client device 106 may be in communication with a cloud DVR system to receive video content. A client device 106 may comprise one or more of any other type of device, such as, and without limitation, a television, a smart television, a personal computer (PC), a laptop computer, a mobile computing device, a smartphone, a tablet computing device, a home gateway, or the like. A client device 106 may combine any features or characteristics of the foregoing examples. For instance, a client device 106 may include a cable STB with integrated DVR features.

The content provider(s) 102 may comprise at least one database, such as one or more of the databases 104, 110. The one or more databases 104, 110 may each store data indicative of the content distributed by the content provider(s) 102. Alternatively, one or more of the databases 104, 110 may not be included in the content provider(s) 102 but may instead be associated with a third-party and in communication with the content provider(s) 102.

The content provider(s) 102 may be configured to receive, from the client device(s) client interaction data 107 associated with the content distributed by the content provider(s) 102. The database 104 may store the client interaction data 107. For example, the content provider(s) 102 may cause the client interaction data 107 to be stored in the database 104, such as by sending the received client interaction data 107 to the database 104 for storage. The client interaction data 107 may be curated by one or more individuals. For example, the client interaction data 107 may be stored in the database 104 in a format that is modifiable by the one or more individuals.

The client interaction data 107 may indicate how users associated with at least a subset of the client devices 106 have interacted with various content items during output of those content items. For example, the client interaction data 107 may indicate at least one of, for each of a plurality of different content items, if/when each the subset of devices 106 rewinded the content item, if/when each of the subset of devices 106 initiated output of closed captioning, or if/when each the subset of devices 106 terminated output of closed captioning.

For example, the client interaction data 107 may indicate, for a content item, how many of the client devices 106 rewinded the content item and when, during output of the content item, those client devices 106 rewinded the content item. For example, a client device 106a may have rewinded the content item at 00:46:00 during output of the content item. Another client device 106b may have rewinded the content item at 00:45:51. The client interaction data 107 may indicate both of these timestamps.

The client interaction data 107 may indicate, for the content item, how many of the client devices 106 turned on closed captioning during output of the content item and when, during output of the content item, those client devices 106 turned on closed captioning. For example, a client device 106a may have turned on closed captioning at 00:33:10 during output of the content item. Another client device 106b may have turned on closed captioning at 00:32:53 during output of the content item. The client interaction data 107 may indicate both of these timestamps.

The client interaction data 107 may indicate, for the content item, how many of the client devices 106 turned off closed captioning during output of the content item and when, during output of the content item, those client devices 106 turned off closed captioning. For example, a client device 106a may have turned off closed captioning at 00:35:20 during output of the content item. Another client device 106b may have turned off closed captioning at 00:36:13 during output of the content item. The client interaction data 107 may indicate both of these timestamps.

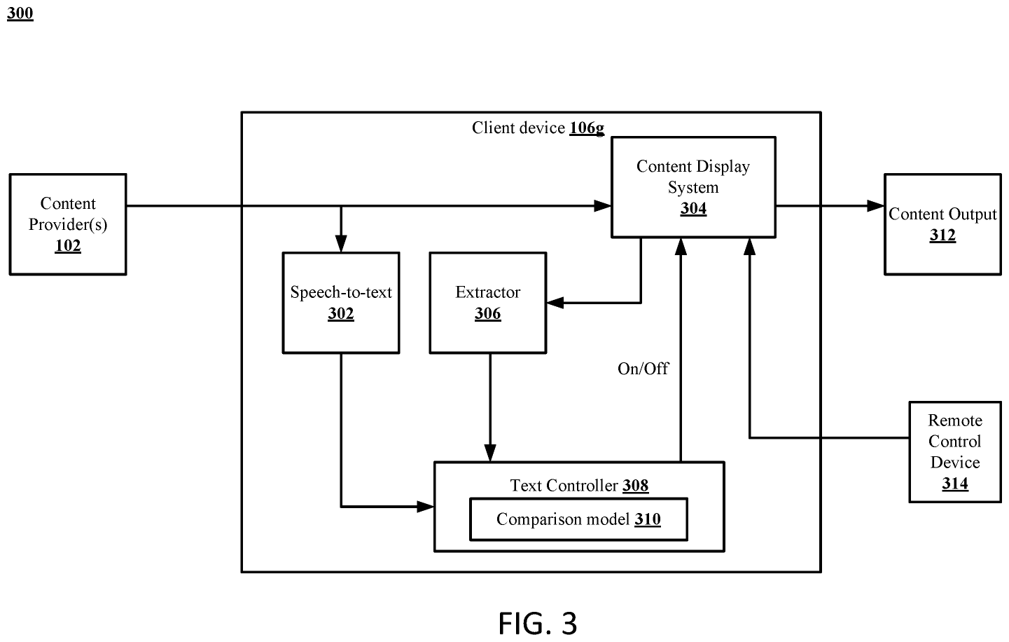

The client interaction data 107 may indicate if/when closed captioning was turned on/off by the subset of devices 106 in response to manual input from a user associated with the device 106. For example, a user may indicate (such as by selecting a button on a remote-control device or via voice command) that the user wants to turn closed captioning on/off. Additionally, or alternatively, the client interaction data 107 may indicate if/when closed captioning was turned on/off by the subset of devices 106 automatically (e.g., by the device itself, without any user input and without using any existing client interaction data 107). FIG. 3, discussed in more detail below, show a client device that is configured to automatically turn on/off closed captioning during output of content items, without any user input (and without using any existing client interaction data 107).

The database 104 may store reduced intelligibility portion data 108. The reduced intelligibility portion data 108 may indicate, for a content item, one or more portions of the content item associated with reduced intelligibility. A portion of a content item associated with reduced intelligibility may include a portion of the content item that is difficult to hear (e.g., dialogue at a low volume or audio that is difficult to hear) and/or a portion of the content item that is difficult to understand or comprehend (i.e., garbled dialogue that may or may not be at a low volume). For example, the reduced intelligibility portion data 108 may indicate, for a content item, a start time, an end time and/or a duration associated with the portion(s) of the content item associated with reduced intelligibility.

The content provider(s) 102 may be configured to utilize the client interaction data 107 to determine the reduced intelligibility portion data 108. The content provider 102 may, for example, input the client interaction data 107 into the trained machine learning model 114, to determine the reduced intelligibility portion data 108. The machine learning model 114 may be trained to determine start times and end times for portion(s) of the content item associated with reduced intelligibility, given the client interaction data 107 associated with that content item as input. Any suitable machine learning model may be employed. For example, the machine learning model 114 may be implemented using, or be based on, one or more deep learning models, such as convolutional neural networks (CNNs), recurrent neural networks (RNNs), long short term memory networks (LSTMs), generative adversarial networks (GANs), and/or multilayer perceptrons (MPLs).

For example, the client interaction data 107 may indicate that a client device 106a turned on closed captioning at 00:33:10 during output of the content item and turned off closed captioning at 00:35:20 during output of the content item. The client interaction data 107 may additionally indicate that a client device 106b turned on closed captioning at 00:32:53 during output of the content item and turned off closed captioning at 00:36:13 during output of the content item. The machine learning model 114 may receive, as input, this client interaction data 107 and output a predicted start time and end time associated with portion(s) of the content item associated with reduced intelligibility.

The machine learning model 114 may be implemented in one or more computing devices. Such a computing device may comprise one or more processors and memory storing instructions that, when executed by the one or more processors, cause the computing device to perform one or more of the various methods or techniques described here. The memory may comprise volatile memory (e.g., random access memory (RAM)) and/or non-volatile memory (e.g., a hard or solid-state drive). The memory may comprise a non-transitory computer-readable medium. The computing device may comprise one or more input devices, such as a mouse, a keyboard, or a touch interface. The computing device may comprise one or more output devices, such as a monitor or other video display. The computing device may comprise an audio input and/or output. The computing device may comprise one or more network communication interfaces, such as a wireless transceiver (e.g., Wi-Fi or cellular) or wired network interface (e.g., ethernet). The one or more network communication interfaces may be configured to connect to the network 116.

The machine learning model 114 may comprise one or more computing devices and/or network devices. For example, the machine learning model 114 may comprise one or more networked servers. The machine learning model 114 may comprise a data storage device and/or system, such as a network-attached storage (NAS) system.

As an alternative to, or in addition to, using the machine learning model 114 to determine the start times and end times for portion(s) of the content item associated with reduced intelligibility, the content provider(s) 102 may be configured to determine an average or mode of the closed captioning initiation times indicated by the client interaction data 107 to determine a predicted start time associated with portion(s) of the content item associated with reduced intelligibility. Likewise, the content provider(s) 102 may be configured to determine an average or mode of the closed captioning termination times indicated by the client interaction data 107 to determine a predicted end time associated with portion(s) of the content item associated with reduced intelligibility.

For example, the client interaction data 107 may indicate that a client device 106a turned on closed captioning at 00:33:10 during output of the content item and that a client device 106b turned on closed captioning at 00:32:53 during output of the content item. The content provider(s) 102 may determine an average of these two initiation times to determine a predicted start time associated with a portion of the content item associated with reduced intelligibility. Likewise, the client interaction data 107 may indicate that a client device 106a turned off closed captioning at 00:35:20 during output of the content item and that a client device 106b turned off closed captioning at 00:36:13 during output of the content item. The content provider(s) 102 may determine an average of these two termination times to determine a predicted end time associated with the portions of the content item associated with reduced intelligibility.

Additionally, or alternatively, a client device 106 may determine the reduced intelligibility portion data 108. For example, the client device 106 may determine the reduced intelligibility portion data 108 associated with the content item while the client device 106 is causing output of the content item. The client device 106 may determine the reduced intelligibility portion data 108 associated with the content item in real-time as the client device 106 is causing output of the content item.

To determine the reduced intelligibility portion data 108 during output of the content item, the client device 106 may utilize the speech-to-text converter 112. The client device may be configured to continuously monitor audio associated with the content item to determine if the audio is able to be converted to text (e.g., by the speech-to-text converter 112). Audio may be able to be converted to text if the speech-to-text converter 112 is able to convert the audio to text that matches (e.g., corresponds to) closed captioning data associated with the content item. For example, audio may be able to be converted to text if the speech-to-text converter 112 is able to convert the audio to text that substantially matches the closed captioning data associated with the content item. The text generated by the speech-to-text converter 112 may substantially match the closed captioning data if a similarity between the text and the closed captioning data satisfies (e.g., meets or exceeds) a threshold.

If audio associated with a portion of the content item substantially matches the closed captioning data associated with that portion of the content item, that portion of the content item may not be associated with reduced intelligibility. Conversely, if audio associated with a portion of the content item does not substantially match the closed captioning data associated with that portion of the content item, that portion of the content item may be associated with reduced intelligibility. The reduced intelligibility portion data 108 may indicate those portions of the content item that are associated with reduced intelligibility.

The database 104 may be implemented in the form of a network storage, such as, for example, a cloud-based storage accessible by other systems or devices via a network, such as the network 116. In addition to the client interaction data 107 and the reduced intelligibility portion data 108, the database 104 may store other information associated with the content items or a service provider that maintains or operates the database 104. The database 104 may comprise one or more computing devices and/or network devices. For example, the database 104 may comprise one or more networked servers. The database 104 may comprise a data storage device and/or system, such as a network-attached storage (NAS) system.

The closed captioning database 110 may store the closed captioning data associated with various content items. For example, the closed captioning database 110 may store closed captioning data associated with content items output by the content provider(s) 102. Closed captioning displays the audio portion of a content item as text on an interface of the client device 106 during output of the content item. Each content item output by the content provider(s) 102 may be associated with closed captioning data. The closed captioning data may indicate the text that corresponds to the audio portion of each content item.

The closed captioning database 110 may be implemented in the form of a network storage, such as, for example, a cloud-based storage accessible by other systems or devices via a network, such as the network 116. In addition to the closed captioning data, the closed captioning database 110 may store other information associated with the content items or a service provider that maintains or operates the closed captioning database 110. The closed captioning database 110 may comprise one or more computing devices and/or network devices. For example, the closed captioning database 110 may comprise one or more networked servers. The closed captioning database 110 may comprise a data storage device and/or system, such as a network-attached storage (NAS) system.

The content provider(s) 102 may be configured to cause output of text and/or termination of the output of text during output of a content item. For example, the content provider(s) 102 may include a text controller 103 that is configured to automatically cause output of text and cause termination of the output of text during output of a content item. The content provider(s) 102 may be configured to automatically cause output of text during output of the portion(s) of the content item associated with reduced intelligibility and automatically cause termination of the output of text after output of the portion(s) of the content item associated with reduced intelligibility.

For example, the content provider(s) 102 may determine that output of a content item has been initiated via at least one client device 106. If the content provider(s) 102 determines that output of a content item has been initiated via a client device 106c, the content provider(s) 102 may retrieve an indication of at least one portion of the content item associated with reduced intelligibility. For example, the content provider(s) 102 may retrieve, from the database 104, reduced intelligibility portion data 108 associated with the content item.

The indication of the at least one portion of the content item associated with reduced intelligibility may indicate to the content provider(s) 102 a start time, end time, and/or a duration associated with the at least one portion of the content item associated with reduced intelligibility. The content provider(s) 102 may send, to the client device 106c during output of the content item, an indication or instruction to initiate the output of text at the start time indicated by the reduced intelligibility portion data 108. The content provider(s) 102 may additionally, or alternatively, send, to the client device 106c during output of the content item, an indication or instruction to terminate the output of text at the end time indicated by the reduced intelligibility portion data 108. The content provider(s) 102 may additionally, or alternatively, send, to the client device 106c during output of the content item, an indication of the duration of the at least one portion of the content item associated with reduced intelligibility indicated by the reduced intelligibility portion data 108.

The content provider(s) 102 may send a single indication/instruction that includes one or more of the start time, the end time, or the duration. Alternatively, one or more of the start time, the end time, and the duration may be sent via different indications/instructions. The indication(s)/instruction(s) may be sent when the content provider(s) 102 determines that output of a content item has been initiated via at least one client device 106. Alternatively, or additionally, the indication(s)/instruction(s) may be sent when output of the at least one portion of the content item associated with reduced intelligibility is approaching. For example, the indication(s)/instruction(s) may be sent several minutes or seconds in advance of output of the at least one portion of the content item associated with reduced intelligibility. Alternatively, or additionally, the indication(s)/instruction(s) may be sent in real-time.

The client devices 106 may be configured to receive these instructions/indications from the content provider(s) 102. In response to receiving these instructions/indications from the content provider(s) 102, the client devices 106 may be configured to execute the instructions. For example, the client devices 106 may be configured to initiate or terminate the output of text during output of a content item in accordance with the instructions/indications received from the content provider(s) 102. The client devices 106 may be configured to initiate or terminate the output of text during output of a content item in accordance with the instructions/indications received from the content provider(s) 102 by causing output of the text via a device that is different the device outputting the content item.

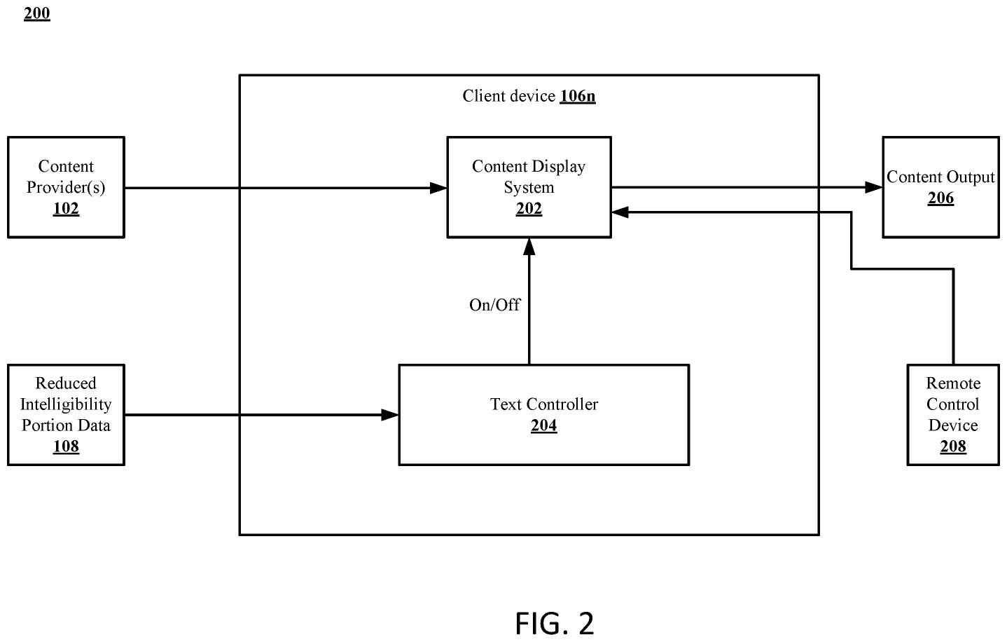

The client devices 106 may additionally, or alternatively, be configured to automatically initiate the output of text at a start time of at least one portion of the content item associated with reduced intelligibility and/or automatically terminate the output of the text at an end time of the at least one portion of the content item associated with reduced intelligibility without receiving instruction from the content provider(s) 102. A client device 106 that is configured to automatically initiate the output of text at a start time of at least one portion of the content item associated with reduced intelligibility and/or automatically terminate the output of the text at an end time of the at least one portion of the content item associated with reduced intelligibility without receiving instruction from the content provider(s) 102 is discussed in more detail below with regard to FIG. 2.

For example, a client device 106d may be configured to determine that output of a content item has been initiated via the client device 106d. For example, the client device 106d may determine that a user has selected the content item for output. If the client device 106d initiates output of the content item, the client device 106d may receive, such as from the content provider(s) 102, an indication of at least one portion of the content item associated with reduced intelligibility. For example, the client device 106d may retrieve, from the database 104, reduced intelligibility portion data 108 associated with the content item.

The indication of the at least one portion of the content item associated with reduced intelligibility may indicate to the client device 106d a start time, end time, and/or a duration associated with the at least one portion of the content item associated with reduced intelligibility. The client device 106d may, during output of the content item, initiate the output of text at the start time indicated by the reduced intelligibility portion data 108. The client device 106d may, during output of the content item, terminate the output of text at the end time indicated by the reduced intelligibility portion data 108. The client device 106d may additionally, or alternatively, initiate the output of text at the start time indicated by the reduced intelligibility portion data 108 and terminate the output of text after the duration indicated by the reduced intelligibility portion data 108 has elapsed.

The client devices 106 may be configured to initiate the output of text during output of a content item by retrieving, from the closed captioning database 110, closed captioning data associated the content item. The content provider(s) 102 may additionally, or alternatively, be configured to send the closed captioning data to the client devices 106. As discussed above, the closed captioning data associated with the content item may indicate the text that corresponds to the audio portion of each content item. This text may be output by the client devices 106, such as during output of the at least one portion of the content item associated with reduced intelligibility.

The client devices 106 may additionally, or alternatively, be configured to initiate the output of text during output of a content item by utilizing the speech-to-text converter 112 to generate the text for output. While shown in FIG. 1 as being separate from the client devices 106, it should be appreciated that the speech-to-text converter 112 can additionally, or alternatively, be included as a component of one or more of the client devices 106. The client devices 106 may utilize the speech-to-text converter 112, during output of a content item, to generate a text translation/conversion of the audio portion of the content item. For example, the client devices 106 may utilize the speech-to-text converter 112 to generate a text translation or conversion of the audio portion of the content item in real-time during output of a content item. The text translation or conversion may be output by the client devices 106, such as during output of the at least one portion of the content item associated with reduced intelligibility.

The content provider(s) 102 may additionally, or alternatively, be configured to utilize the speech-to-text converter 112, during output of a content item, to generate a text translation/conversion of the audio portion of the content item. The content provider(s) 102 may send, to the client devices 106, the text translation or conversion for output during output of the at least one portion of the content item associated with reduced intelligibility.

The speech-to-text converter 112 may be implemented in one or more computing devices. Such a computing device may comprise one or more processors and memory storing instructions that, when executed by the one or more processors, cause the computing device to perform one or more of the various methods or techniques described here. The memory may comprise volatile memory (e.g., random access memory (RAM)) and/or non-volatile memory (e.g., a hard or solid-state drive). The memory may comprise a non-transitory computer-readable medium. The computing device may comprise one or more input devices, such as a mouse, a keyboard, or a touch interface. The computing device may comprise one or more output devices, such as a monitor or other video display. The computing device may comprise an audio input and/or output. The computing device may comprise one or more network communication interfaces, such as a wireless transceiver (e.g., Wi-Fi or cellular) or wired network interface (e.g., ethernet). The one or more network communication interfaces may be configured to connect to the network 116.

The speech-to-text converter 112 may comprise one or more computing devices and/or network devices. For example, the speech-to-text converter 112 may comprise one or more networked servers. The speech-to-text converter 112 may comprise a data storage device and/or system, such as a network-attached storage (NAS) system.

FIG. 2 shows an example architecture 200 of a client device (e.g., client device 106n). The client device 106n may be configured to initiate the output of text at a start time of at least one portion of the content item associated with reduced intelligibility and/or terminate the output of the text at an end time of the at least one portion of the content item associated with reduced intelligibility without receiving instruction from the content provider(s) 102.

The client device 106n may comprise a content display system 202 and a text controller 204. The content display system 202 may be configured to receive, from the content provider(s) 102, a content item that a user associated with the client device 106n has selected for output. For example, the user may, via a remote-control device 208, send an indication of a selection of the content item to the content display system 202. The client device 106n may be configured to determine that output of a content item has been initiated via the client device 106n. For example, the client device 106n may determine that a user has selected the content item for output, the content item has been received, and/or that the content item is being output (e.g., displayed, played back) via a content output interface 206 associated with the client device 106n. The content output interface 206 may be included in the client device 106n or may be separate from the client device 106n.

If the client device 106n determines that output of the content item has been initiated via the client device 106n, the client device 106n may receive, such as from the content provider(s) 102, an indication of at least one portion of the content item associated with reduced intelligibility. For example, the client device 106n may retrieve, from the database 104, reduced intelligibility portion data 108 associated with the content item.

The reduced intelligibility portion data 108 associated with the content item may indicate to the client device 106n a start time, end time, and/or a duration associated with the at least one portion of the content item associated with reduced intelligibility. The client device 106n may, during output of the content item, automatically initiate the output of text at the start time indicated by the reduced intelligibility portion data 108. The client device 106n may, during output of the content item, automatically terminate the output of text at the end time indicated by the reduced intelligibility portion data 108. The client device 106n may additionally, or alternatively, automatically initiate the output of text at the start time indicated by the reduced intelligibility portion data 108 and automatically terminate the output of text after the duration indicated by the reduced intelligibility portion data 108 has elapsed.

The client device 106n may be configured to initiate the output of text during output of a content item by retrieving, from a closed captioning database, closed captioning data associated the content item. The closed captioning database may be included in the client device 106n and/or may be separate from the client device 106n. The content provider(s) 102 may additionally, or alternatively, be configured to send the closed captioning data to the client device 106n.

As discussed above, the closed captioning data associated with the content item may indicate the text that corresponds to the audio portion of each content item. This text may be output by the client device 106n, such as during output of the at least one portion of the content item associated with reduced intelligibility. For example, the text may be output by the client device 106n via the content output interface 206 associated with the client device 106n. The text may, for example, be overlaid on the content item during output of the content item via the content output interface 206. Alternatively, the text may be output on an interface of a device other than the client device 106n. Both the other device and the client device 106n may be associated with the same user.

The client device 106n may additionally, or alternatively, be configured to initiate the output of text during output of a content item by utilizing the speech-to-text converter 112 to generate the text for output. The speech-to-text converter may be included in the client device 106n or may be separate from the client device 106n. For example, the client device 106n may utilize the speech-to-text converter to generate a text translation or conversion of the audio portion of the content item in real-time during output of a content item. The text translation or conversion may be output by the client device 106n, such as during output of the at least one portion of the content item associated with reduced intelligibility.

As discussed above with regard to FIG. 1, the client interaction data 107 may indicate if/when closed captioning was turned on/off by client devices 106 in response to manual input from a user associated with the device 106. For example, a user may indicate (such as by selecting a button on a remote-control device or via voice command) that the user wants to turn closed captioning on/off. Additionally, or alternatively, the client interaction data 107 may indicate if/when closed captioning was turned on/off by the devices 106 automatically (e.g., by the device itself, without any user input and without using existing client interaction data 107).

FIG. 3 shows an example architecture 300 of a client device 106g that is configured to automatically turn on/off closed captioning during output of content items, without any user input and without using existing client interaction data 107. The client device 106g may be configured to send, such as back to the content provider(s) 102, data indicating if/when closed captioning was automatically turned on/off during output of a content item. Such data may be saved as client interaction data 107. For example, such data may be saved as client interaction data 107 in the database 104.

The client device 106g may comprise a content display system 304 and a text controller 308. The content display system 304 may be configured to receive, from the content provider(s) 102, a content item that a user associated with the client device 106g has selected for output. For example, the user may, via a remote-control device 314, send an indication of a selection of the content item to the content display system 304. The client device 106g may be configured to determine that output of a content item has been initiated via the client device 106g. For example, the client device 106g may determine that a user has selected the content item for output, the content item has been received, and/or that the content item is being output (e.g., displayed, played back) via a content output interface 312 associated with the client device 106g. The content output interface 312 may be included in the client device 106g or may be separate from the client device 106g.

As the content item is being output via the content output interface 312, an extractor 306 may determine (e.g., extract) text data from content item. The extracted text data may comprise closed captioning data associated with the content item. As the content item is being output via the content output interface 312, a speech-to-text converter 302 may be converting, in real-time, the audio associated with the content item into a text translation. The text controller 308 may comprise a comparison model 310. The comparison model 310 may compare the extracted text data to the text translation. If the text translation is not the same as, or similar enough to, the extracted text data, this may indicate that the audio in that portion of the content item is associated with reduced intelligibility. If the audio in a portion of the content item is difficult enough to hear, the speech-to-text converter 302 may not even be able to convert the audio associated with that portion of the content item into a text translation. If the speech-to-text converter 302 is not able to convert the audio associated with a portion of the content item into a text translation, then this may indicate that the audio in that portion of the content item is associated with reduced intelligibility.

The client device 106g may automatically turn on closed captioning if the comparison model 310 determines that the text translation is not the same as, or similar enough to, the extracted text data (or that the speech-to-text converter 302 is not able to convert the audio associated a portion of the content item into a text translation). The client device 106g may automatically turn off closed captioning when the comparison model 310 determine that the text translation is the same as, or similar enough to, the extracted text data. The client device 106g may repeat this process throughout the duration of the entire output of the content item. The client device 106g may be configured so that the automatic closed captioning feature can be turned on or off, such as by a user. For example, if a user of the client device 106g turns off the automatic closed captioning feature, then the client device 106g may not automatically turn closed captioning on/off. If a user of the client device 106g turns on the automatic closed captioning feature, then the client device 106g may automatically turn closed captioning on/off, such as in the manner described above.

The comparison model 310 may be configured to determine key words in the extracted data that indicate that audio is intended to be unintelligible. The content item may comprise one or more portions that are associated with audio that is intended to be unintelligible to viewers. The extracted data associated with a portion of the content item that is intended to be intelligible may comprise one or more key words indicating that the corresponding audio is intended to be unintelligible. A key word may comprise, for example, “unintelligible, “muffled,” etc. If the comparison model 310 determines a key word in the extracted data associated with a portion of the content item, the client device 106g may not turn on closed captioning during output of the portion of the content item, even if the comparison model 310 determines that the text translation is not the same as, or similar enough to, the extracted text data for that portion.

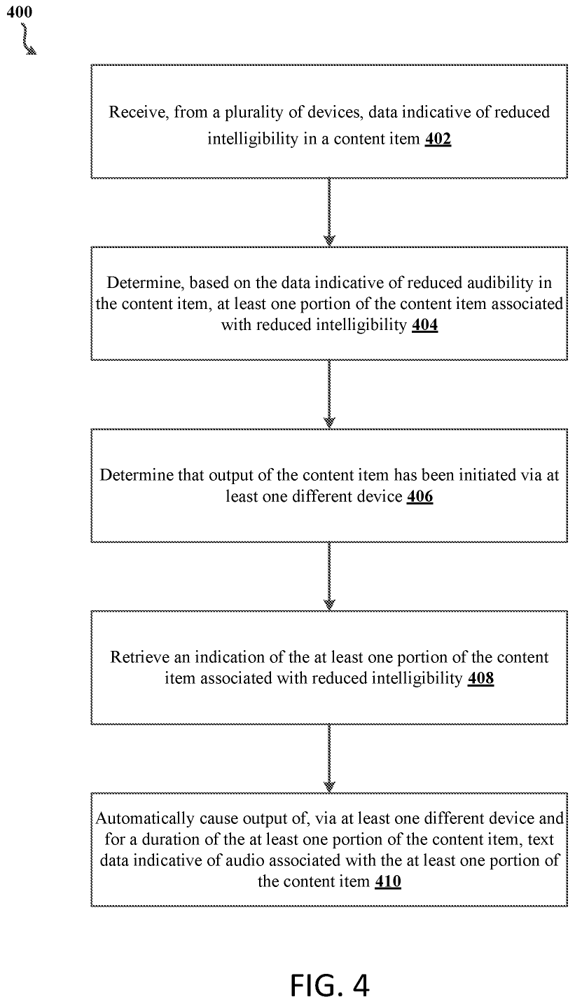

FIG. 4 shows an example method 400 for text output. The method may be performed, for example, by a content provider (e.g., content provider(s) 102) or a component of a content provider (e.g., text controller 103). The method 400 may be performed to automatically cause output of text data indicative of audio associated with at least one portion of the content item associated with reduced intelligibility, for the duration of the at least one portion of the content item. Performance of the method 400 may improve user-experience during consumption of the content item.

Data may be received, from a plurality of devices (e.g., client devices 106). At 402, data indicative of reduced intelligibility (e.g., reduced audibility, audio that is difficult to understand or comprehend, low volume audio, difficult to hear audio, etc.) in a content item may be received from the plurality of devices. The data indicative of reduced intelligibility may include, for example, client interaction data (e.g., client interaction data 107) associated with a content item distributed by the content provider(s) 102. The received data may be stored in a database (e.g., database 104).

The data indicative of reduced intelligibility may indicate how users associated with the plurality of devices interacted with the content item during previous outputs (e.g., presentations) of the content item. For example, the data indicative of reduced intelligibility may indicate at least one of if/when each the plurality of devices rewinded the content item during output of the content item, if/when each of the plurality of devices initiated output of closed captioning during output of the content item, or if/when each the plurality of devices terminated output of closed captioning during output of the content item.

For example, the data indicative of reduced intelligibility may indicate, for the content item, how many of the plurality of devices rewinded the content item and when, during output of the content item, those devices rewinded the content item. For example, a first device of the plurality of devices may have rewinded the content item at 00:46:00 during output of the content item. A second device of the plurality of devices may have rewinded the content item at 00:45:51. The data indicative of reduced intelligibility may indicate both of these timestamps.

The data indicative of reduced intelligibility may indicate, for the content item, how many of the plurality of devices turned on closed captioning during output of the content item and when, during output of the content item, those devices turned on closed captioning. For example, the first device of the plurality of devices may have turned on closed captioning at 00:33:10 during output of the content item. The second device of the plurality of devices may have turned on closed captioning at 00:32:53 during output of the content item. The data indicative of reduced intelligibility may indicate both of these timestamps.

The data indicative of reduced intelligibility may indicate, for the content item, how many of the plurality of devices turned off closed captioning during output of the content item and when, during output of the content item, those devices turned off closed captioning. For example, the first device of the plurality of devices may have turned off closed captioning at 00:35:20 during output of the content item. The second device of the plurality of devices may have turned off closed captioning at 00:36:13 during output of the content item. The data indicative of reduced intelligibility may indicate both of these timestamps.

The data indicative of reduced intelligibility may indicate if/when closed captioning was turned on/off by the plurality of devices in response to manual input from a user associated with the device. For example, a user may indicate (such as by selecting a button on a remote-control device or via voice command) that the user wants to turn closed captioning on/off. Additionally, or alternatively, the data indicative of reduced intelligibility may indicate if/when closed captioning was turned on/off by the plurality of devices automatically (e.g., by the device itself, without any user input). FIG. 3, discussed above, shows a device that is configured to automatically turn on/off closed captioning during output of content items, without any user input (and without using any existing client interaction data 107).

At 404, at least one portion of the content item associated with reduced intelligibility may be determined. The at least one portion of the content item may be determined based on the data indicative of reduced intelligibility in the content item. Determining the at least one portion of the content item associated with reduced intelligibility may comprise determining at least one of a start time, end time, or duration associated with the at least one portion of the content item associated with reduced intelligibility.

For example, the data indicative of reduced intelligibility in the content item may be input into a trained machine learning model (e.g., machine learning model 114), and the machine learning model may output predicted start times and end times for portion(s) of the content item associated with reduced intelligibility. As an alternative to, or in addition to, using the machine learning model to determine the start times and end times for portion(s) of the content item associated with reduced intelligibility, an average or mode of the closed captioning initiation times (as indicated by the data indicative of reduced intelligibility in the content item) may be determined in order to determine a predicted start time associated with portion(s) of the content item associated with reduced intelligibility. Likewise, an average or mode of the closed captioning termination times (as indicated by the data indicative of reduced intelligibility in the content item) may be determined in order to determine a predicted end time associated with portion(s) of the content item associated with reduced intelligibility.

Data indicative of the at least one portion of the content item associated with reduced intelligibility may be stored in a database, such as in the database 104 as reduced intelligibility portion data 108. For example, data indicative of at least one of the determined start time, end time, or duration of the at least one portion of the content item associated with reduced intelligibility may be stored in the database.

The content item may be output again at a later time by a different device (e.g., a device from which data indicative of reduced intelligibility has not been received). At 406, it may be determined that output of the content item has been initiated via at least one different device. For example, it may be determined that a user associated with the at least one different device has selected the content item for output.

The data indicative of the at least one portion of the content item may be utilized to automatically cause initiation of and/or automatically cause termination of the output of text data indicative of audio associated with the at least one portion of the content item during output of the content item via the at least one different device. At 408, an indication of the at least one portion of the content item associated with reduced intelligibility may be retrieved. For example, the data indicative of the at least one portion of the content item associated with reduced intelligibility may be retrieved from the database in which it is stored.

At 410, output of text data indicative of audio associated with the at least one portion of the content item may be caused via the at least one different device and for a duration of the at least one portion of the content item. The output of the text data may be automatically cause. For example, the output of the text data indicative of audio associated with the at least one portion of the content item may be caused during output of the at least one portion of the content item associated with reduced intelligibility. Causing output of text data indicative of audio associated with the at least one portion of the content item may include causing closed captioning to be turned on at the start time associated with the at least one portion of the content item and causing closed captioning to be turned off at the end time associated with the at least one portion of the content item. The text data indicative of audio associated with the at least one portion of the content item may be overlaid on the content item during output of the at least one portion of the content item associated with reduced intelligibility. For example, the text data indicative of audio associated with the at least one portion of the content item may be automatically overlaid on the content item during output of the at least one portion of the content item associated with reduced intelligibility.

For example, causing output of text data indicative of audio associated with the at least one portion of the content item via the at least one different device may comprise sending, to the at least one different device, an indication or instruction to initiate the output of text at the start time associated with the at least one portion of the content item. Causing output of text data indicative of audio associated with the at least one portion of the content item via the at least one different device may additionally, or alternatively, comprise sending, to the at least one different client device, an indication or instruction to terminate the output of text at the end time associated with the at least one portion of the content item. Causing output of text data indicative of audio associated with the at least one portion of the content item via the at least one different device may additionally, or alternatively, comprise sending, to the at least one different client device, an indication of the duration of the at least one portion of the content item associated with reduced intelligibility.

As discussed above, the at least one different client device may receive the indication(s) and output text data indicative of audio associated with the at least one portion of the content item for the duration of the at least one portion of the content item. For example, the at least one different client device may automatically turn on closed captioning at the start time associated with the at least one portion of the content item and automatically turn off closed captioning at the end time associated with the at least one portion of the content item. Additionally, or alternatively, the at least one different client device may utilize a speech-to-text converter (e.g., speech-to-text converter 112) to generate the text for output.

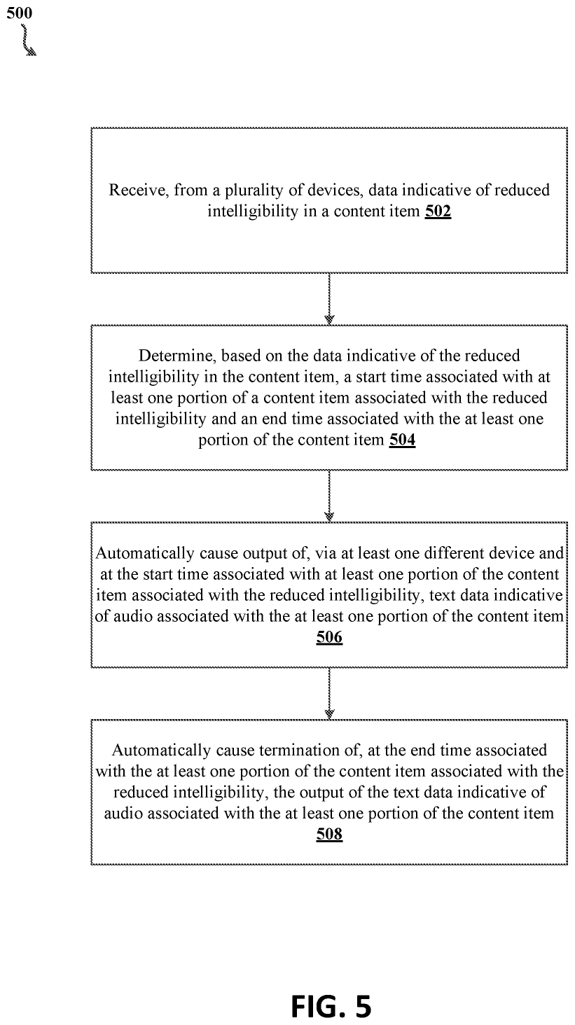

FIG. 5 shows an example method 500 for automatic text output. The method may be performed, for example, by a content provider (e.g., content provider(s) 102) or a component of a content provider (e.g., text controller 103). The method 500 may be performed to automatically cause output of text data indicative of audio associated with at least one portion of the content item associated with reduced intelligibility, for the duration of the at least one portion of the content item. Performance of the method 500 may improve user-experience during consumption of the content item.

Data may be received, from a plurality of devices (e.g., client devices 106). At 502, data indicative of reduced intelligibility (e.g., reduced audibility, audio that is difficult to understand or comprehend, low volume audio, difficult to hear audio, etc.) in a content item may be received from the plurality of devices. The data indicative of reduced intelligibility may include, for example, client interaction data (e.g., client interaction data 107) associated with a content item distributed by the content provider(s) 102. The received data may be stored in a database (e.g., database 104).

The data indicative of reduced intelligibility may indicate how users associated with the plurality of devices interacted with the content item during previous outputs (e.g., presentations) of the content item. For example, the data indicative of reduced intelligibility may indicate at least one of if/when each the plurality of devices rewinded the content item during output of the content item, if/when each of the plurality of devices initiated output of closed captioning during output of the content item, or if/when each the plurality of devices terminated output of closed captioning during output of the content item.

For example, the data indicative of reduced intelligibility may indicate, for the content item, how many of the plurality of devices rewinded the content item and when, during output of the content item, those devices rewinded the content item. For example, a first device of the plurality of devices may have rewinded the content item at 00:46:00 during output of the content item. A second device of the plurality of devices may have rewinded the content item at 00:45:51. The data indicative of reduced intelligibility may indicate both of these timestamps.

The data indicative of reduced intelligibility may indicate, for the content item, how many of the plurality of devices turned on closed captioning during output of the content item and when, during output of the content item, those devices turned on closed captioning. For example, the first device of the plurality of devices may have turned on closed captioning at 00:33:10 during output of the content item. The second device of the plurality of devices may have turned on closed captioning at 00:32:53 during output of the content item. The data indicative of reduced intelligibility may indicate both of these timestamps.

The data indicative of reduced intelligibility may indicate, for the content item, how many of the plurality of devices turned off closed captioning during output of the content item and when, during output of the content item, those devices turned off closed captioning. For example, the first device of the plurality of devices may have turned off closed captioning at 00:35:20 during output of the content item. The second device of the plurality of devices may have turned off closed captioning at 00:36:13 during output of the content item. The data indicative of reduced intelligibility may indicate both of these timestamps.

The data indicative of reduced intelligibility may indicate if/when closed captioning was turned on/off by the plurality of devices in response to manual input from a user associated with the device. For example, a user may indicate (such as by selecting a button on a remote-control device or via voice command) that the user wants to turn closed captioning on/off. Additionally, or alternatively, the data indicative of reduced intelligibility may indicate if/when closed captioning was turned on/off by the plurality of devices automatically (e.g., by the device itself, without any user input). FIG. 3, discussed above, shows a device that is configured to automatically turn on/off closed captioning during output of content items, without any user input (and without using any existing client interaction data 107).

At 504, a start time associated with at least one portion of a content item associated with the reduced intelligibility and an end time associated with the at least one portion of the content item may be determined. The start time and the end time may be determined based on the data indicative of the reduced intelligibility in the content item. A duration associated with the at least one portion of the content item associated with reduced intelligibility may additionally be determined.

For example, the data indicative of reduced intelligibility in the content item may be input into a trained machine learning model (e.g., machine learning model 114), and the machine learning model may output predicted start times and end times for portion(s) of the content item associated with reduced intelligibility. As an alternative to, or in addition to, using the machine learning model to determine the start times and end times for portion(s) of the content item associated with reduced intelligibility, an average or mode of the closed captioning initiation times (as indicated by the data indicative of reduced intelligibility in the content item) may be determined in order to determine a predicted start time associated with portion(s) of the content item associated with reduced intelligibility. Likewise, an average or mode of the closed captioning termination times (as indicated by the data indicative of reduced intelligibility in the content item) may be determined in order to determine a predicted end time associated with portion(s) of the content item associated with reduced intelligibility. Data indicative of the start times and end times for the portion(s) of the content item associated with reduced intelligibility may be stored in a database, such as in the database 104 as reduced intelligibility portion data 108.

The content item may be output again at a later time by at least one different device (e.g., a device from which data indicative of reduced intelligibility has not been received). At 506, output of text data indicative of audio associated with the at least one portion of the content item may be caused via the at least one different device. The output may be caused at the start time associated with at least one portion of the content item associated with the reduced intelligibility. For example, automatically causing output of text data indicative of audio associated with the at least one portion of the content item at the start time associated with at least one portion of the content item via the at least one different device may comprise sending, to the at least one different device, an indication or instruction to initiate the output of text at the start time associated with the at least one portion of the content item. Automatically causing output of the text data indicative of audio associated with the at least one portion of the content item may comprise automatically causing the text data to be overlaid on the content item at the start time associated with at least one portion of the content item associated with the reduced intelligibility.

At 508, termination of the output of the text data indicative of audio associated with the at least one portion of the content item may be caused via the at least one different device. The termination may be caused at the end time associated with the at least one portion of the content item associated with the reduced intelligibility. For example, automatically causing termination of the output of text data indicative of audio associated with the at least one portion of the content item at the end time associated with at least one portion of the content item via the at least one different device may comprise sending, to the at least one different device, an indication or instruction to terminate the output of text at the end time associated with the at least one portion of the content item. Automatically causing termination of the output of the text data indicative of audio associated with the at least one portion of the content item may comprise automatically terminating the overlay of the text data on the content item at the end time associated with at least one portion of the content item associated with the reduced intelligibility.

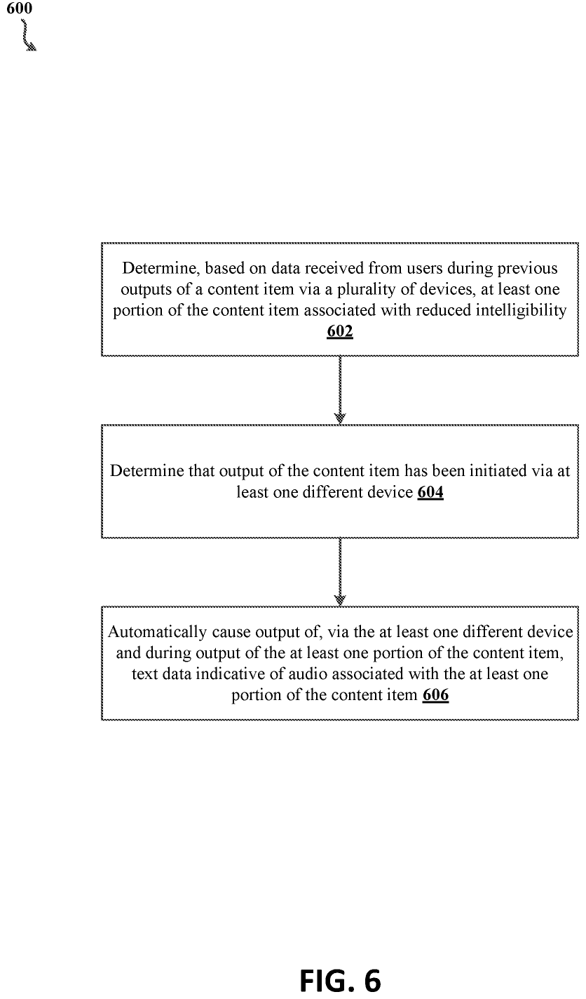

FIG. 6 shows an example method 600 for automatic text output. The method may be performed, for example, by a content provider (e.g., content provider(s) 102) or a component of a content provider (e.g., text controller 103). The method 600 may be performed to automatically cause output of text data indicative of audio associated with at least one portion of the content item associated with reduced intelligibility, for the duration of the at least one portion of the content item. Performance of the method 600 may improve user-experience during consumption of the content item.

Data may be received, from a plurality of devices (e.g., client devices 106). The data may be indicative of reduced intelligibility (e.g., reduced audibility, audio that is difficult to understand or comprehend, low volume audio, difficult to hear audio, etc.) in a content item. The data indicative of reduced intelligibility may include, for example, client interaction data (e.g., client interaction data 107) associated with a content item distributed by the content provider(s) 102. The received data may be stored in a database (e.g., database 104). The data indicative of reduced intelligibility may indicate how users associated with the plurality of devices interacted with the content item during previous outputs (e.g., presentations) of the content item. For example, the data indicative of reduced intelligibility may indicate at least one of if/when each the plurality of devices rewinded the content item during output of the content item, if/when each of the plurality of devices initiated output of closed captioning during output of the content item, or if/when each the plurality of devices terminated output of closed captioning during output of the content item.

At 602, at least one portion of the content item associated with reduced intelligibility may be determined. The at least one portion of the content item may be determined based on the data received from users during previous outputs (e.g., presentations) of a content item via a plurality of devices. Determining the at least one portion of the content item associated with reduced intelligibility may comprise determining at least one of a start time, end time, or duration associated with the at least one portion of the content item associated with reduced intelligibility.

For example, the data indicative of reduced intelligibility in the content item may be input into a trained machine learning model (e.g., machine learning model 114), and the machine learning model may output predicted start times and end times for portion(s) of the content item associated with reduced intelligibility. As an alternative to, or in addition to, using the machine learning model to determine the start times and end times for portion(s) of the content item associated with reduced intelligibility, an average or mode of the closed captioning initiation times (as indicated by the data indicative of reduced intelligibility in the content item) may be determined in order to determine a predicted start time associated with portion(s) of the content item associated with reduced intelligibility. Likewise, an average or mode of the closed captioning termination times (as indicated by the data indicative of reduced intelligibility in the content item) may be determined in order to determine a predicted end time associated with portion(s) of the content item associated with reduced intelligibility.

The content item may be output again at a later time by a different device (e.g., a device from which data indicative of reduced intelligibility has not been received. At 604, it may be determined that output of the content item has been initiated via at least one different device. For example, it may be determined that a user associated with the at least one different device has selected the content item for output.

At 606, output of text data indicative of audio associated with the at least one portion of the content item may be caused via the at least one different device and during output of the at least one portion of the content item. Automatically causing output of text data indicative of audio associated with the at least one portion of the content item may include automatically causing closed captioning to be turned on at the start time associated with the at least one portion of the content item and automatically causing closed captioning to be turned off at the end time associated with the at least one portion of the content item. The text data indicative of audio associated with the at least one portion of the content item may be automatically overlaid on the content item during output of the at least one portion of the content item associated with reduced intelligibility.

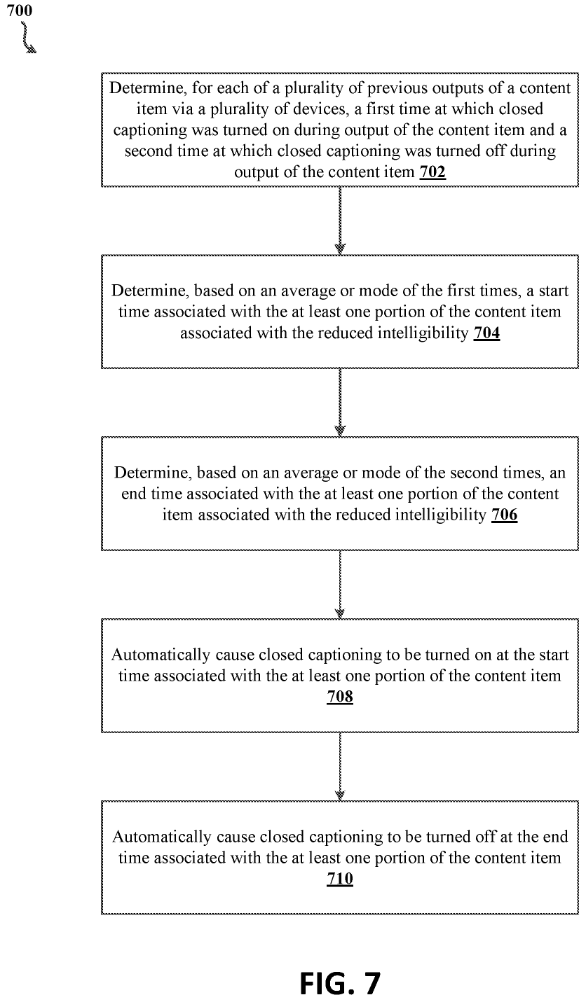

FIG. 7 shows an example method 700 for automatic text output. The method may be performed, for example, by a content provider (e.g., content provider(s) 102) or a component of a content provider (e.g., text controller 103). The method 700 may be performed to automatically cause output of text data indicative of audio associated with at least one portion of the content item associated with reduced intelligibility (e.g., reduced audibility, audio that is difficult to understand or comprehend, low volume audio, difficult to hear audio, etc.) for the duration of the at least one portion of the content item. Performance of the method 700 may improve user-experience during consumption of the content item.

At 702, a first time at which closed captioning was turned on during output of a content item may be determined for each of a plurality of previous outputs (e.g., presentations) of the content item. The plurality of previous outputs of the content item may have occurred via a plurality of devices. A second time at which closed captioning was turned off during output of the content item for each of the plurality of previous outputs of the content item may additionally, or alternatively be determined.

For example, a first device of the plurality of devices may have turned on closed captioning at 00:10:15 during output of the content item and turned off closed captioning at 00:12:12. A second device of the plurality of devices may have turned on closed captioning at 00:10:25 during output of the content item and turned off closed captioning at 00:12:01. A third device of the plurality of devices may have turned on closed captioning at 00:10:25 during output of the content item and turned off closed captioning at 00:12:12. The first time associated with the first device is 00:10:15, the first time associated with the second device is 00:10:25, and the first time associated with the third device is 00:10:25. The second time associated with the first device is 00:12:12, the second time associated with the second device is 00:12:01, and the second time associated with the third device is 00:12:12.

At 704, a start time associated with the at least one portion of the content item associated with the reduced intelligibility may be determined based on an average or mode of the first times. If the start time is determined based on an average of the first times, the start time may be equal to the average of the start times associated with each of the plurality of devices. For example, the start time may be equal to the average of 00:10:15, 00:10:25, and 00:10:25. If the start time is determined based on a mode of the first times, the start time may be equal to the mode of the start times associated with each of the plurality of devices. For example, the start time may be equal to the mode of 00:10:15, 00:10:25, and 00:10:25.

At 706, and end time associated with the at least one portion of the content item associated with the reduced intelligibility may be determined based on an average or mode of the second times. If the end time is determined based on an average of the second times, the end time may be equal to the average of the end times associated with each of the plurality of devices. For example, the end time may be equal to the average of 00:12:12, 00:12:01, and 00:12:12. If the end time is determined based on a mode of the second times, the end time may be equal to the mode of the end times associated with each of the plurality of devices. For example, the end time may be equal to the mode of 00:12:12, 00:12:01, and 00:12:12.

At 708, output of closed captioning may be caused at the start time associated with the at least one portion of the content item. For example, a different device may be caused to automatically turn on closed captioning at the start time associated with the at least one portion of the content item. At 710, termination of the output of closed captioning may be caused at the end time associated with the at least one portion of the content item. For example, the different device may be caused to automatically turn off closed captioning on at the end time associated with the at least one portion of the content item.

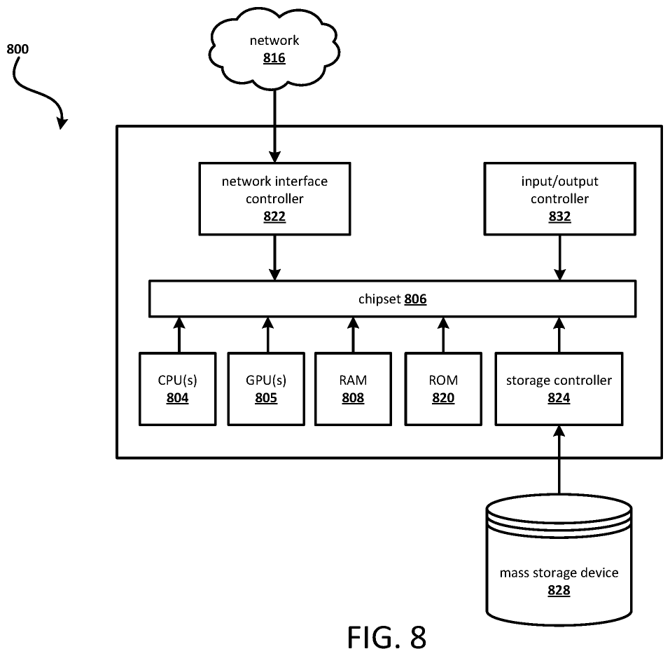

FIG. 8 shows an example computing device 800 that may represent any of the various devices or entities shown in FIG. 1, including, for example, the content provider(s) 102, the client devices 106, the speech-to-text converter 112, the network 116, or the machine learning model 114. That is, the computing device 800 shown in FIG. 8 may be any smartphone, server computer, workstation, access point, router, gateway, tablet computer, laptop computer, notebook computer, desktop computer, personal computer, network appliance, PDA, e-reader, user equipment (UE), mobile station, fixed or mobile subscriber unit, pager, wireless sensor, consumer electronics, or other computing device, and may be utilized to execute any aspects of the methods and apparatus described herein, such as to implement any of the apparatus of FIGS. 1-3 or any of the methods described in relation to FIGS. 4-7.

The computing device 800 may include a baseboard, or “motherboard,” which is a printed circuit board to which a multitude of components or devices may be connected by way of a system bus or other electrical communication paths. One or more central processing units (CPUs or “processors”) 804 may operate in conjunction with a chipset 806. The CPU(s) 804 may be standard programmable processors that perform arithmetic and logical operations necessary for the operation of the computing device 800.

The CPU(s) 804 may perform the necessary operations by transitioning from one discrete physical state to the next through the manipulation of switching elements that differentiate between and change these states. Switching elements may generally include electronic circuits that maintain one of two binary states, such as flip-flops, and electronic circuits that provide an output state based on the logical combination of the states of one or more other switching elements, such as logic gates. These basic switching elements may be combined to create more complex logic circuits including registers, adders-subtractors, arithmetic logic units, floating-point units, and the like.

The CPU(s) 804 may be augmented with or replaced by other processing units, such as GPU(s) 805. The GPU(s) 805 may comprise processing units specialized for but not necessarily limited to highly parallel computations, such as graphics and other visualization-related processing.

A chipset 806 may provide an interface between the CPU(s) 804 and the remainder of the components and devices on the baseboard. The chipset 806 may provide an interface to a random-access memory (RAM) 808 used as the main memory in the computing device 800. The chipset 806 may provide an interface to a computer-readable storage medium, such as a read-only memory (ROM) 820 or non-volatile RAM (NVRAM) (not shown), for storing basic routines that may help to start up the computing device 800 and to transfer information between the various components and devices. ROM 820 or NVRAM may also store other software components necessary for the operation of the computing device 800 in accordance with the aspects described herein.

The computing device 800 may operate in a networked environment using logical connections to remote computing nodes and computer systems of the system 80. The chipset 806 may include functionality for providing network connectivity through a network interface controller (NIC) 822. A NIC 822 may be capable of connecting the computing device 800 to other computing nodes over the system 80 via a network 816. It should be appreciated that multiple NICs 822 may be present in the computing device 800, connecting the computing device to other types of networks and remote computer systems. The NIC may be configured to implement a wired local area network technology, such as IEEE 802.3 (“Ethernet”) or the like. The NIC may also comprise any suitable wireless network interface controller capable of wirelessly connecting and communicating with other devices or computing nodes on the system 800. For example, the NIC 822 may operate in accordance with any of a variety of wireless communication protocols, including for example, the IEEE 802.11 (“Wi-Fi”) protocol, the IEEE 802.16 or 802.20 (“WiMAX”) protocols, the IEEE 802.15.4a (“Zigbee”) protocol, the 802.15.3c (“UWB”) protocol, or the like.

The computing device 800 may be connected to a mass storage device 828 that provides non-volatile storage (i.e., memory) for the computer. The mass storage device 828 may store system programs, application programs, other program modules, and data, which have been described in greater detail herein. The mass storage device 828 may be connected to the computing device 800 through a storage controller 824 connected to the chipset 806. The mass storage device 828 may consist of one or more physical storage units. A storage controller 824 may interface with the physical storage units through a serial attached SCSI (SAS) interface, a serial advanced technology attachment (SATA) interface, a fiber channel (FC) interface, or other type of interface for physically connecting and transferring data between computers and physical storage units.

The computing device 800 may store data on a mass storage device 828 by transforming the physical state of the physical storage units to reflect the information being stored. The specific transformation of a physical state may depend on various factors and on different implementations of this description. Examples of such factors may include, but are not limited to, the technology used to implement the physical storage units and whether the mass storage device 828 is characterized as primary or secondary storage and the like.

For example, the computing device 800 may store information to the mass storage device 828 by issuing instructions through a storage controller 824 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computing device 800 may read information from the mass storage device 828 by detecting the physical states or characteristics of one or more particular locations within the physical storage units.

In addition to the mass storage device 828 described herein, the computing device 800 may have access to other computer-readable storage media to store and retrieve information, such as program modules, data structures, or other data. It should be appreciated by those skilled in the art that computer-readable storage media may be any available media that provides for the storage of non-transitory data and that may be accessed by the computing device 800.

By way of example and not limitation, computer-readable storage media may include volatile and non-volatile, non-transitory computer-readable storage media, and removable and non-removable media implemented in any method or technology. However, as used herein, the term computer-readable storage media does not encompass transitory computer-readable storage media, such as signals. Computer-readable storage media includes, but is not limited to, RAM, ROM, erasable programmable ROM (“EPROM”), electrically erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage, other magnetic storage devices, or any other non-transitory medium that may be used to store the desired information in a non-transitory fashion.

A mass storage device, such as the mass storage device 828 depicted in FIG. 8, may store an operating system utilized to control the operation of the computing device 800. The operating system may comprise a version of the LINUX operating system. The operating system may comprise a version of the WINDOWS SERVER operating system from the MICROSOFT Corporation. According to additional aspects, the operating system may comprise a version of the UNIX operating system. Various mobile phone operating systems, such as IOS and ANDROID, may also be utilized. It should be appreciated that other operating systems may also be utilized. The mass storage device 828 may store other system or application programs and data utilized by the computing device 800.

The mass storage device 828 or other computer-readable storage media may also be encoded with computer-executable instructions, which, when loaded into the computing device 800, transforms the computing device from a general-purpose computing system into a special-purpose computer capable of implementing the aspects described herein. These computer-executable instructions transform the computing device 800 by specifying how the CPU(s) 804 transition between states, as described herein. The computing device 800 may have access to computer-readable storage media storing computer-executable instructions, which, when executed by the computing device 800, may perform the methods described in relation to FIGS. 8-9.

A computing device, such as the computing device 800 depicted in FIG. 8, may also include an input/output controller 832 for receiving and processing input from a number of input devices, such as a keyboard, a mouse, a touchpad, a touch screen, an electronic stylus, or other type of input device. Similarly, an input/output controller 832 may provide output to a display, such as a computer monitor, a flat-panel display, a digital projector, a printer, a plotter, or other type of output device. It will be appreciated that the computing device 800 may not include all of the components shown in FIG. 8, may include other components that are not explicitly shown in FIG. 8, or may utilize an architecture completely different than that shown in FIG. 8.

As described herein, a computing device may be a physical computing device, such as the computing device 800 of FIG. 8. A computing device may also include a virtual machine host process and one or more virtual machine instances. Computer-executable instructions may be executed by the physical hardware of a computing device indirectly through interpretation and/or execution of instructions stored and executed in the context of a virtual machine.

It is to be understood that the methods and systems described herein are not limited to specific methods, specific components, or to particular implementations. It is also to be understood that the terminology used herein is for the purpose of describing particular embodiments only and is not intended to be limiting.

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes—from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey data indicating a preferred or ideal embodiment. “Such as” is not used in a restrictive sense, but for explanatory purposes.

Components and devices are described that may be used to perform the described methods and systems. When combinations, subsets, interactions, groups, etc., of these components are described, it is understood that while specific references to each of the various individual and collective combinations and permutations of these may not be explicitly described, each is specifically contemplated and described herein, for all methods and systems. This applies to all aspects of this application including, but not limited to, operations in described methods. Thus, if there are a variety of additional operations that may be performed it is understood that each of these additional operations may be performed with any specific embodiment or combination of embodiments of the described methods.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable instructions (e.g., computer software or program code) embodied in the storage medium. More particularly, the present methods and systems may take the form of web-implemented computer software. Any suitable computer-readable storage medium may be utilized including hard disks, CD-ROMs, optical storage devices, or magnetic storage devices.

Embodiments of the methods and systems are described above with reference to block diagrams and flowchart illustrations of methods, systems, apparatuses, and computer program products. It will be understood that each block of the block diagrams and flowchart illustrations, and combinations of blocks in the block diagrams and flowchart illustrations, respectively, may be implemented by computer program instructions. These computer program instructions may be loaded on a general-purpose computer, special-purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that may direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

The various features and processes described herein may be used independently of one another or may be combined in various ways. All possible combinations and sub-combinations are intended to fall within the scope of this disclosure. In addition, certain methods or process blocks may be omitted in some implementations. The methods and processes described herein are also not limited to any particular sequence, and the blocks or states relating thereto may be performed in other sequences that are appropriate. For example, described blocks or states may be performed in an order other than that specifically described, or multiple blocks or states may be combined in a single block or state. The example blocks or states may be performed in serial, in parallel, or in some other manner. Blocks or states may be added to or removed from the described example embodiments. The example systems and components described herein may be configured differently than described. For example, elements may be added to, removed from, or rearranged compared to the described example embodiments.

It will also be appreciated that various items are shown as being stored in memory or on storage while being used, and that these items or portions thereof may be transferred between memory and other storage devices for purposes of memory management and data integrity. Alternatively, in other embodiments, some or all of the software modules and/or systems may execute in memory on another device and communicate with the shown computing systems via inter-computer communication. Furthermore, in some embodiments, some or all of the systems and/or modules may be implemented or provided in other ways, such as at least partially in firmware and/or hardware, including, but not limited to, one or more application-specific integrated circuits (“ASICs”), standard integrated circuits, controllers (e.g., by executing appropriate instructions, and including microcontrollers and/or embedded controllers), field-programmable gate arrays (“FPGAs”), complex programmable logic devices (“CPLDs”), etc. Some or all of the modules, systems, and data structures may also be stored (e.g., as software instructions or structured data) on a computer-readable medium, such as a hard disk, a memory, a network, or a portable media article to be read by an appropriate device or via an appropriate connection. The systems, modules, and data structures may also be transmitted as generated data signals (e.g., as part of a carrier wave or other analog or digital propagated signal) on a variety of computer-readable transmission media, including wireless-based and wired/cable-based media, and may take a variety of forms (e.g., as part of a single or multiplexed analog signal, or as multiple discrete digital packets or frames). Such computer program products may also take other forms in other embodiments. Accordingly, the present invention may be practiced with other computer system configurations.

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its operations be performed in a specific order. Accordingly, where a method claim does not actually recite an order to be followed by its operations or it is not otherwise specifically stated in the claims or descriptions that the operations are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; and the number or type of embodiments described in the specification.

It will be apparent to those skilled in the art that various modifications and variations may be made without departing from the scope or spirit of the present disclosure. Other embodiments will be apparent to those skilled in the art from consideration of the specification and practices described herein. It is intended that the specification and example figures be considered as exemplary only, with a true scope and spirit being indicated by the following claims.

What is claimed is:

1. A method comprising:
receiving, from a plurality of devices, data indicative of reduced intelligibility in a content item;
determining, based on the data indicative of reduced intelligibility in the content item, at least one portion of the content item associated with reduced intelligibility; and
causing output of, via at least one different device and for a duration of the at least one portion of the content item, text data indicative of audio associated with the at least one portion of the content item.

2. The method of claim 1, wherein the output of the text data indicative of audio associated with the at least one portion of the content item is automatically caused during output of the at least one portion of the content item associated with reduced intelligibility.

3. The method of claim 1, further comprising:
determining that output of the content item has been initiated via the at least one different device; and
retrieving an indication of the at least one portion of the content item associated with reduced intelligibility.

4. The method of claim 1, wherein determining the at least one portion of the content item associated with reduced intelligibility comprises:
determining a start time associated with the at least one portion of the content item associated with reduced intelligibility; and
determining an end time associated with the at least one portion of the content item associated with reduced intelligibility.

5. The method of claim 4, wherein causing output of the text data indicative of audio associated with the at least one portion of the content item comprises:
automatically causing closed captioning to be turned on at the start time associated with the at least one portion of the content item; and
automatically causing closed captioning to be turned off at the end time associated with the at least one portion of the content item.

6. The method of claim 1, wherein determining the at least one portion of the content item associated with reduced intelligibility comprises determining, using a machine learning model, a start time and an end time associated with the at least one portion of the content item associated with reduced intelligibility.

7. The method of claim 1, wherein the data indicative of reduced intelligibility comprises at least one of data indicating when the plurality of devices rewinded the content item, data indicating when the plurality of devices initiated output of closed captioning, or data indicating when each of the plurality of devices terminated output of closed captioning.

8. The method of claim 1, wherein the reduced intelligibility in the content item comprises at least one of low volume audio, difficult to hear audio, or difficult to comprehend audio.

9. The method of claim 1, wherein the data indicative of reduced intelligibility in the content item is received at a network associated with a content provider.

10. The method of claim 1, wherein the plurality of client devices comprises at least one of a set-top box (STB), a television, a smart television, a personal computer (PC), a laptop computer, a mobile computing device, a smartphone, a tablet computing device, a home gateway, or the like.

11. A method comprising:
receiving, from a plurality of devices, data indicative of reduced intelligibility in a content item;
causing output of, via at least one different device and at a start time associated with at least one portion of the content item associated with the reduced intelligibility, text data indicative of audio associated with the at least one portion of the content item; and
causing termination of, at an end time associated with the at least one portion of the content item associated with the reduced intelligibility, the output of the text data indicative of audio associated with the at least one portion of the content item.

12. The method of claim 11, further comprising:
determining, based on the data indicative of the reduced intelligibility in the content item, the start time associated with the at least one portion of the content item and the end time associated with the at least one portion of the content item.

13. The method of claim 11, further comprising:
determining, using a machine learning model and based on the data indicative of the reduced intelligibility in the content item, the start time and the end time associated with the at least one portion of the content item associated with the reduced intelligibility.

14. The method of claim 11, wherein the output of the text data indicative of audio associated with the at least one portion of the content item is automatically caused during output of the at least one portion of the content item via at least one another device.

15. The method of claim 11, wherein the reduced intelligibility in the content item comprises at least one of low volume audio, difficult to hear audio, or difficult to comprehend audio.

16. A method comprising:
determining, based on data received from users during previous presentations of a content item via a plurality of devices, at least one portion of the content item associated with reduced intelligibility;
determining that output of a content item has been initiated via at least one different device; and
causing output of, via the at least one different device and during output of the at least one portion of the content item, text data indicative of audio associated with the at least one portion of the content item.

17. The method of claim 16, wherein determining the at least one portion of the content item associated with reduced intelligibility comprises:
determining, for each of the previous presentations of the content item via the plurality of devices, a first time at which closed captioning was turned on during output of the content item and a second time at which closed captioning was turned off during output of the content item.

18. The method of claim 16, wherein determining the at least one portion of the content item associated with reduced intelligibility further comprises:
determining, based on an average or mode of the first times, a start time associated with the at least one portion of the content item associated with the reduced intelligibility; and
determining, based on an average or mode of the second times, an end time associated with the at least one portion of the content item associated with the reduced intelligibility.

19. The method of claim 18, wherein automatically causing output of the text data indicative of audio associated with the at least one portion of the content item comprises:
causing output of the text data at the start time; and
causing termination of the output of the text data at the end time.

20. The method of claim 16, wherein automatically causing output of the text data indicative of audio associated with the at least one portion of the content item comprises:
determining, in real-time and based on audio-to-text conversion, text data indicative of audio associated with the at least one portion of the content item.
